(19) United States
(12) Patent Application Publication
(10) Pub. No.: US 2016/0038875 A1
(43) Pub. Date: Feb. 11, 2016

(54) CuCHA MATERIAL FOR SCR CATALYSIS

(71) Applicant: UMICORE AG & CO. KG, Hanau-Wolfgang (DE)

(72) Inventor: Frank-Walter SCHUETZE, Haibach (DE)

(73) Assignee: UMICORE AG & CO. KG, Hanau-Wolfgang (DE)

(21) Appl. No.: 14/780,163

(22) PCT Filed: Apr. 1, 2014
(86) PCT No.: PCT/EP2014/056537

§ 371 Date: Sep. 25, 2015

(30) Foreign Application Priority Data
Apr. 5, 2013 (DE) 102013005749.3

(51) Int. Cl. B01D 53/94; B01J 37/02; B01J 29/76

(52) U.S. Cl. CPC B01D 53/9418; B01J 29/763; B01J 37/0246; B01J 2229/186; B01D 2255/50; B01D 2255/20761

(57) ABSTRACT

The present invention relates to a catalyst material which is capable, at high temperatures, of converting nitrogen oxides in exhaust gas, particularly from vehicles driven by lean-running internal combustion engines, in the presence of ammonia into harmless nitrogen.

The present invention relates to a catalyst material which is capable, at high temperatures, of converting nitrogen oxides in exhaust gas, particularly from vehicles driven by lean-running internal combustion engines, in the presence of ammonia into harmless nitrogen.

The exhaust gas of lean-running internal combustion engines, e.g. diesel engines, also contains particulate matter (PM) and nitrogen oxides (NOₓ) in addition to the harmful gases carbon monoxide (CO) and hydrocarbons (HC) resulting from incomplete combustion of the fuel. In addition, the exhaust gas from diesel engines, contains up to 15 vol % oxygen. It is known that the oxidizable harmful gases CO and HC can be converted to carbon dioxide (CO₂) and water (H₂O) by passing them over a suitable oxidation catalytic converter and that particulates can be removed by passing the exhaust gas through a suitable particulate filter.

A known method for removing nitrogen oxides from oxygen-containing (lean) exhaust gases is the method of selective catalytic reduction (SCR method) using ammonia in an appropriate catalyst, the SCR catalyst. In this method, the nitrogen oxides to be removed from the exhaust gas are converted to nitrogen and water with ammonia. The ammonia used as a reduction agent can be generated in the exhaust system as a secondary emission in oxygen- or oxidant-poor (rich) operating phases, or it is made available in the exhaust gas line by the metered addition of a precursor compound from which ammonia can be formed such as urea, ammonium carbamate or ammonium formate and, where appropriate, subsequent hydrolysis.

The use of zeolite-based SCR catalysts is known from numerous publications. For example, U.S. Pat. No. 4,961,917 describes a method for the reduction of nitrogen oxides with ammonia using a catalyst containing iron and/or copper as a promoter next to a zeolite with defined characteristics. Other SCR catalysts based on transition metal-exchanged zeolites and methods for the selective catalytic reduction using such SCR catalysts are described for example in EP 1 495 804 A1, U.S. Pat. No. 6,914,026 B2 and EP 1 147 801 B1.

Even in WO 9427709, catalysts based on zeolites with the chabazite structure (CHA) are proposed for the decomposition of nitrous oxide. The fact that these can be exchanged with copper was also mentioned. The exchange rate is preferably given with 2-5 wt % of the metal based on the total weight of the catalyst. As a ratio of silica to alumina, it is demanded that this should take at least a value of 55.

In U.S. Pat. No. 6,709,644 B2, the preparation of zeolites of the chabazite type is discussed. It is stated that these zeolites may be used in particular for the reduction of nitrogen oxides, and can have silica to alumina ratios which are in excess of 10. It is further stated that the zeolite may contain a metal ion which enables the reduction of nitrogen oxides to be performed even in the presence of an excess of oxygen. As typical techniques by which the ion exchange can be carried out in the zeolite, wet-technical processes are mentioned, in which acetates of the corresponding metal ions can also be used.

To prepare copper-exchanged zeolites, various methods are further described in the literature. These include, for example, ion exchange methods in aqueous solution (U.S. Pat. No. 5,171,553, DE 10 2010 007 626 A1), and solid-state ion exchange methods (DE 10 2006 033 451 A1, DE 10 2006 033 452 A1 and references cited therein).

Furthermore, WO 2008132452 A2 reports on the use of copper-exchanged zeolites of the chabazite type in the reduction of nitrogen oxides. The silica to alumina ratios given here of the zeolites used are in the range of 2-300 or preferably 8-150. A copper-exchanged zeolite of the chabazite type containing 3 wt % copper is presented.

WO 2008106519 A1 also describes copper-exchanged zeolites for use in the reduction of nitrogen oxides. Presently, materials are propagated which should have an SAR of more than 15 and a copper to aluminum ratio of greater than 0.25. The targeted zeolites are preferably prepared by ion exchange with copper acetate-containing solutions.

The authors of WO 2008118434 A1 describe in this document copper-exchanged chabazite types which have firstly a rel. high silica content (SAR>15) and, secondly, at least one weight percent copper oxide based on the total weight of the catalytically active material. It is described that the materials obtainable in this way have a very good stability towards hydrothermal aging.

In WO2012075400 A1, zeolitic aluminosilicates are highlighted, which are derived from the chabazite type. The applicants of this invention propagate corresponding zeolites for the reduction of nitrogen oxides, wherein the materials should contain a relatively low content of promoters such as, for example, copper. Likewise, the authors show that especially those zeolites having a large average crystal size and a relatively low silica to alumina ratio (SAR) are preferable. The specified contents of copper are below 0.24 (Cu:Al content) and the SAR is 10 to 25. The average crystal size is specified at greater than 0.5 μm.

In the doctoral thesis of Dustin W. Fickel, created in 2010 at the University of Delaware, USA, various copper-exchanged zeolites are described in terms of quality in the reduction of nitrogen oxides. Highly exchanged CuCHA zeolites (SAR=12; Cu:Al=0.35) are compared with those with less Cu content (SAR=12; Cu:Al=0.29) (FIG. 5.5).

CA2822788 AA describes CuCHA zeolites as catalysts for the reduction of nitrogen oxide. Here, SAR values from 11 to 14.8 are proposed as being particularly preferred. The crystal sizes of the catalyst material are given as 1-8 μm. The Cu:Al ratio is preferably 0.2-0.4. The zeolites described here are all crystallized using additions of alkali metal ions.

The object of the present invention was nevertheless to provide an ion-exchanged zeolite material based on the chabazite structure, which is able to transform nitrogen oxides into harmless nitrogen in the presence of ammonia in an advantageous manner. These and other tasks, which are apparent to those skilled in the art in an obvious way from the prior art, are solved by the use of a material, which has the characterizing features of the present claim 1. Sub-claims dependent on claim 1 relate to preferred embodiments of the present invention. Furthermore, the present invention is directed to a catalyst, a corresponding catalyst system and a preferred use of the zeolite material according to the invention.

By specifying a CuCHA zeolite material having:

i) a molar SiO₂:Al₂O₃ ratio (SAR) of >10 to <15;

ii) Cu:Al ratios of >0.25 to <0.35, and

iii) an average crystal size from 0.75 to 2 μm,

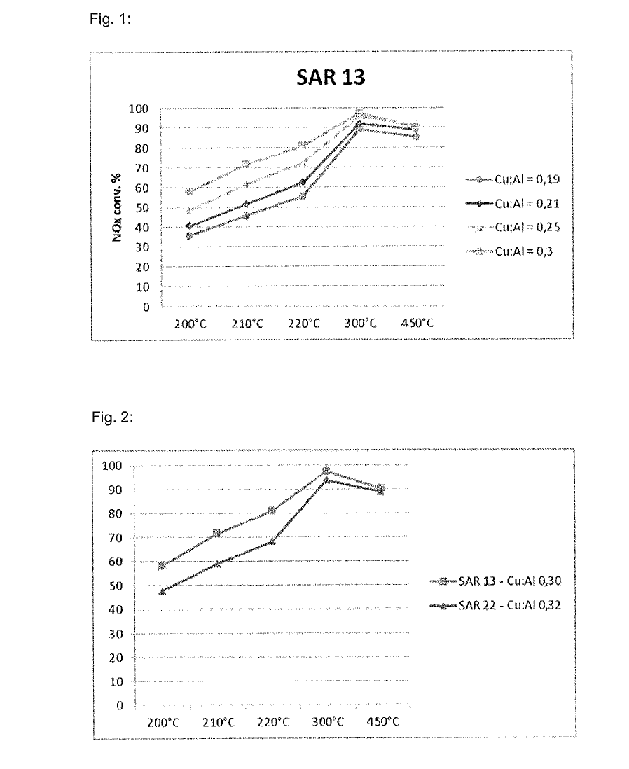

one arrives extremely advantageously but no less surprisingly at the solution to the task posed above. The present material shows excellent stabilities and activities (FIG. 1) in this combination of features, even after hydrothermal aging at 850° C. for 6 hours in the presence of 10% water. In particular, it is surprising that the activity in the low temperature range of 200° C. is relatively high with just under 60%. This could not be readily derived as such from the available prior art.

A parameter that further affects the stability of the material according to the invention is the so-called crystal size. It has proven to be advantageous if the average crystal size is in excess of 0.75 μm. This should advantageously also be the case if the material has been aged hydrothermally at the above-stated conditions. According to the invention, the crystals have an average size between 0.75 and 2 μm. More preferred is an average crystal size of 0.8 to 1.5 μm. Most preferred, the average size of the crystals obtained is a value from 0.8 to 1.2 μm. If the crystal modification obtained is such that axes of different lengths are formed in the crystals, the above-stated values are to be seen on the respective shortest of the axes of the crystals formed. The determination of the crystal size is carried out by SEM (WO2009141324; http://www.iza-online.org/synthesis/VS_{—}2ndEd/SEM.htm; http://portal.tugraz.at/portal/page/portal/felmi/research/Scanning%20Electron%20 Microscopy/Principles%20of%20SEM). As an average value, the sum of the measured crystal sizes is shown relative to the number of crystals.

The present invention shows that it is vital for the formation of the corresponding advantageous CuCHA zeolite material that the ratio of silica to alumina on the one hand and its ratio to the copper existing in and/or on the zeolite, is crucial for the activity and hydrothermal stability as well as the good low-temperature activity of the material according to the invention with low N₂O generation. Therefore, the fact that the CuCHA zeolite material proposed here has a SAR value of 12, 13 or 14 is particularly advantageous. It is most particularly preferred to choose a value of 12 or 13. With respect to these values, the loading of the material with copper ions should be done in such a way that a CuCHA zeolite material is formed, which preferably has a Cu:Al ratio of >0.25 to <0.31. Therefore the molar S10₂:Al₂O₃ ratio (SAR) should have the value of 12, 13 or 14 with a Cu:Al ratio of >0.26 to <0.31, preferably >0.28 to <0.31 and most preferably about 0.29. This material is to be particularly preferred when it has an average crystal size of 0.75-2 μm, preferably 0.8-1.5 μm, most preferably 0.8-1.2 μm.

The CuCHA zeolite materials addressed here are produced as a rule such that the zeolite material is obtained first, which is subsequently brought into contact with copper ions using wet-technical methods. An ion exchange can be carried out analogous to WO2012175409. It is advantageous if the copper is introduced in the finished zeolites exclusively through wet-technical ion exchange. Such methods are well known to the person skilled in the art.

It has proved to be advantageous if the zeolite material is thereby synthesized in its H⁺ form. Advantageously, the ion exchange with copper may subsequently immediately follow, without a further ion exchange happening in the meantime, for example in the NH₄⁺ form. Here, the H⁺ ions contained in the zeolite material exchange places with the copper ions. Alternatively, however, a NH₄⁺ exchange can take place first. In addition to the synthesis in the H⁺ form, i.e. without going through possible crystallization with alkali metal ions and subsequent ion exchange with NH₄⁺ ions, the synthesis of zeolites directly in the NH₄⁺ form has proven favorable. In particular, therefore, it is also preferred to crystallize zeolites in the presence of NH₄⁺ ions without the addition of alkali metal ions, particularly sodium ions, which leads directly to the NH₄⁺ form of the zeolites, and to subsequently convert them into the H⁺ form for the copper exchange. The content of alkali metal ions, particularly sodium ions, in the zeolite is here less than 100 ppm—even without further ion exchange.

Preferably, solutions of copper ions in water are used for the copper exchange. It is preferred that the copper is present in the form of a salt dissolved in water. Particularly preferred is the fact that the anion of the copper salt consists of the residue of an organic acid. In particular, acetic acid, formic acid, tartaric acid or oxalic acid are preferred organic acids used in this context. The use of acetic acid in this context is very particularly preferred. Extremely preferred, therefore, is a CuCHA material having a molar SiO₂:Al₂O₃ ratio (SAR) of 12, 13 or 14 with a Cu:Al ratio of >0.26 to <0.31, preferably >0.28 to <0.31 and most preferably about 0.29, and if it has a crystal size from 0.75 to 2 μm, preferably from 0.8 to 1.5 μm, extremely preferably 0.8-1.2 μm and has been obtained by on exchange with an aqueous solution of copper acetate or copper formate in an initial concentration of 0.2 M to 0.8 M, preferably >0.25 M to <0.6 M. Most preferably, the concentration of copper salt in the solution is about 0.5 M.

As already indicated, the product thus produced and appropriately dimensioned has an extremely good hydrothermal stability. This hydrothermal stability can be measured by temperature-dependent XRD recordings (Finkel et al., J. Chem. Phys. 2010, 114, 1633 et seq.). The [100] reflex can be used for this purpose. It has been shown that the present material begins to lose its stability only above a temperature of 800° C., which can be seen in the decrease of the intensity of this reflex. Accordingly, it is particularly preferred if the stability of the material according to the invention begins to wane (decrease[100] reflex by 10% within 1 hour) only above 800° C., preferably above 810° C. and more preferably above 820° C. and very particularly preferably above 830° C. (measured by the relative intensity of the [100] peaks (XRD)). This is particularly the case with the aforementioned preferably and particularly preferably employed material.

The subject matter of the present invention is also a catalyst, which catalyzes the reduction of nitrogen oxides in the presence of ammonia and comprises the material according to the invention. The catalyst, which can also contain other materials such as binders and other auxiliaries besides the material according to the invention, can be applied as a wash coat on supporting bodies, wherein the supporting bodies advantageously are so-called flow-through monoliths and wall-flow monoliths. Reference is made in this regard to the relevant literature mentioned in the introduction of this application.

In particular, a catalyst system is likewise the subject matter of the present invention, which also includes a material, besides the CuCHA zeolite material according to the invention, that is capable of oxidizing ammonia in the presence of oxygen.

It has proven to be favorable to provide a corresponding oxidizing material at the downstream end of the catalyst according to the invention to preferably oxidize possibly unreacted ammonia to nitrogen. An arrangement is therefore preferable in which the material according to the invention is present together with a catalyst for ammonia oxidation on a supporting body, wherein most preferably the oxidizing material is applied to the downstream end of the supporting body. Here, a system layout can be selected which provides a zoned arrangement of both materials on the supporting body, wherein the materials may be present either flush, with a gap or wholly or partially overlapping on the supporting body. In this regard, reference is also made to the aforementioned literature.

The subject matter of the present invention is also the use of the material according to the invention in a catalyst for reducing nitrogen oxides with ammonia. With respect to further embodiments, with regard to the usage, reference is made to the aforementioned literature.

As part of the present invention, the following class of compounds is understood to be the substance group of zeolites:

Mⁿ⁺_{x/n}[(AlO₂)⁻ₓ(SiO₂)_{y}].zH₂O
The factor n is the charge of the cation M and is usually 1 or 2.
M typically is a cation of a alkali or alkaline earth metal. These cations are required for electrical charge balancing of the negatively-charged aluminum tetrahedrons and are not incorporated into the main grid of the crystal, but will stay in cavities of the grid—and are therefore easily moveable within the grid and even interchangeable afterwards.
The factor z indicates how many water molecules were absorbed by the crystal. Zeolites can absorb water and other low-molecular substances and release it again when heated without their crystal structure being destroyed.
The molar ratio of SiO₂ to AlO₂ and y/x respectively in the empirical formula is referred to as a module. It may not be less than 1 due to Lowenstein's rule.

The zeolites contemplated herein are to be assigned to the structural class of chabazite (CHA). Only pure zeolites without those that contain framework atoms other than aluminum, silicon and oxygen are encompassed. According to the invention, the zeolites presented therefore contain no further elements in their structure. In the ion-exchanged places, there are mainly copper ions and the cations which were used for the preparation of the zeolites. Thus in particular, the content of phosphorus in the material according to the invention is less than 100 ppm. Likewise, the content of residual carbon in the claimed CuCHA is less than 500, preferably less than 200 and most preferably less than 100 ppm. This has particularly been made possible in that the preparation of the corresponding zeolites is carried out without the use of a carbon-containing material.

Such CuCHA catalysts have a superior nitrogen oxide reduction ability with low nitrous oxide production (high selectivity), whereby in particular the low-temperature activity with respect to the reduction of nitrogen oxide is excellent. This was not to be expected in view of the prior art.

### EXAMPLE

The CuCHA zeolite material used is prepared analogously to U.S. Pat. No. 6,709,644, WO 2012145323 A1 or WO 2011073390 A2. Subsequently, the material exchanged with copper is applied to the supporting bodies, dried and calcined. Cores of the supporting bodies are hydrothermally aged at 850° C. for 6 h and at 10% H₂O.

The samples thus obtained are examined at a space velocity of 80,000/h in synthesis gas (500 ppm NO, 500 ppm NH₃, 5% H₂O, 10% O₂, 7.5% CO₂, 350 ppm CO, remainder N₂) with respect to their NOx conversion (FIG. 1 and FIG. 2). It has been shown that average SAR ratios of >10 to <15 coupled with Cu:Al ratios of >0.25 to <0.35 provide the best results.

1. A CuCHA zeolite material having:
i) a molar SiO₂:Al₂O₃ ratio (SAR) of >10 to <15;
ii) Cu:Al ratios of >0.25 to <0.35, and
iii) an average crystal size between 0.75 and 2 μm.

2. A CuCHA zeolite material according to claim 1, wherein the molar SiO₂:Al₂O₃ ratio (SAR) is 12, 13 or 14.

3. A CuCHA zeolite material according to claim 1, wherein the Cu:Al ratio is >0.25 to <0.31.

4. A CuCHA zeolite material according to claim 1, wherein the molar SiO₂:Al₂O₃ ratio (SAR) is 12, 13 or 14 and the Cu:Al ratio is >0.26 to <0.31.

5. A CuCHA zeolite material according to claim 1, wherein, the Cu in the form of a salt with the anion of an organic acid has been used for ion exchange.

6. A CuCHA zeolite material according to claim 1, wherein, its stability begins to wane only above 800° C. (as measured by the relative intensity of the [100] peak (XRD)).

7. Catalyst for the catalytic reduction of nitrogen oxides in the presence of ammonia comprising the material according to claim 1.

8. A catalyst system comprising the catalyst according to claim 7, wherein, this catalyst is present on a supporting body together with a catalyst for ammonia oxidation.

9. A method of reducing nitrogen oxides with ammonia, comprising utilizing the material according to claim 1 in a catalyst that is placed in contract with nitrogen oxides in the presence of ammonia.

10. Method for preparing a CuCHA zeolite material according to claim 1, wherein, the CHA zeolite material is synthesized in the NH₄⁺ form and is subsequently converted into the H⁺ form before the copper exchange takes place.

11. A method of forming a catalyst suited for reducing nitrogen oxides with ammonia, comprising inclusion of the material according to claim 1 in a catalyst.

12. A CuCHA zeolite material according to claim 2, wherein the Cu:Al ratio is >0.25 to <0.31.
